(19) United States
(12) Patent Application Publication
(10) Pub. No.: US 2012/0181255 A1
(43) Pub. Date: Jul. 19, 2012

(54) FLUX ENHANCED HIGH ENERGY DENSITY WELDING

(76) Inventor: Gerald J. Bruck, Oviedo, FL (US)

(21) Appl. No.: 13/005,656

(22) Filed: Jan. 13, 2011

(51) Int. Cl. B23K 9/16; B23K 9/18; B23K 25/00

(52) U.S. Cl. 219/73.2; 219/74; 219/73

(57) ABSTRACT

A method of shielding a weld. The method includes melting a substrate to form a weld pool using a high energy density welding technique of plasma arc welding, laser beam welding, or electron beam welding; and delivering a flux to the weld pool to produce a slag effective to shield against atmospheric contaminants.

### FIELD OF THE INVENTION

The invention relates to the use of flux in high energy density welding techniques. Specifically, a technique for using flux in high energy density welding that may produce a shielding slag sufficient to shield a weld pool and a weld bead from atmospheric contaminants is disclosed.

### BACKGROUND OF THE INVENTION

Substrates being welded and/or joined by a welding process need to be shielded from atmospheric contaminants. Otherwise, molten substrate material, formerly molten substrate material that is still heated, and heated substrate material in the region adjacent the location of the molten material (i.e. material in the heat affected zone) may react with the atmosphere (i.e. oxidize) and may absorb other contaminants present in the atmosphere. This contaminates the weld bead and the weld bead/joint may suffer in terms of strength and longevity.

Welding techniques that utilize shielding may shield by any of several shielding methods. Shielded metal arc welding (SMAW) utilizes an electrode coated with a consumable flux material. During the welding process the electrode is consumed, i.e. it is melted and becomes part of the weld pool, as does the flux. The flux generates a shielding gas that shields the weld pool and surrounding substrate from atmospheric contamination. The flux also enters the weld pool and forms a slag on the surface of the weld pool which remains on a weld bead when the weld pool solidifies into a weld bead. While present in the volume of the weld pool the flux may also deoxidize and/or remove impurities present in the weld pool. Some electrode flux coatings have virtually no affect on deposit composition, i.e. the flux is neutral, while others make modest additions to the deposit composition, i.e. the flux is active.

High energy density welding techniques, including plasma arc welding (PAW), laser beam welding (LBW), and electron beam welding (EBW) do not use flux. Instead, PAW and LBW deliver a supply of shielding gas to the weld during the process which provides the necessary shielding from atmospheric contaminants. EBW is performed in a vacuum, and thus shielding gas has not been used. However, atmospheric contamination of weld beads still occurs in the high energy density welding techniques, and thus there is room for improvement in the art.

### BRIEF DESCRIPTION OF THE DRAWINGS

The invention is explained in the following description in view of the drawings that show:

FIG. 1 depicts conventional gas shielded metal arc welding.

FIG. 2 depicts conventional plasma arc welding.

FIG. 3 depicts flux enhanced plasma arc welding.

### DETAILED DESCRIPTION OF THE INVENTION

The present inventor has identified weaknesses in shielding methods used in high energy density welding techniques, and discloses a shielding method unique to these high energy welding techniques. This new high energy density welding shielding technique employs knowledge and materials already present in other welding techniques, and as such, implementation will be easy and inexpensive to incorporate. As a result of this innovation, quality and yields of welds made using high energy density welding techniques will increase at minimal cost.

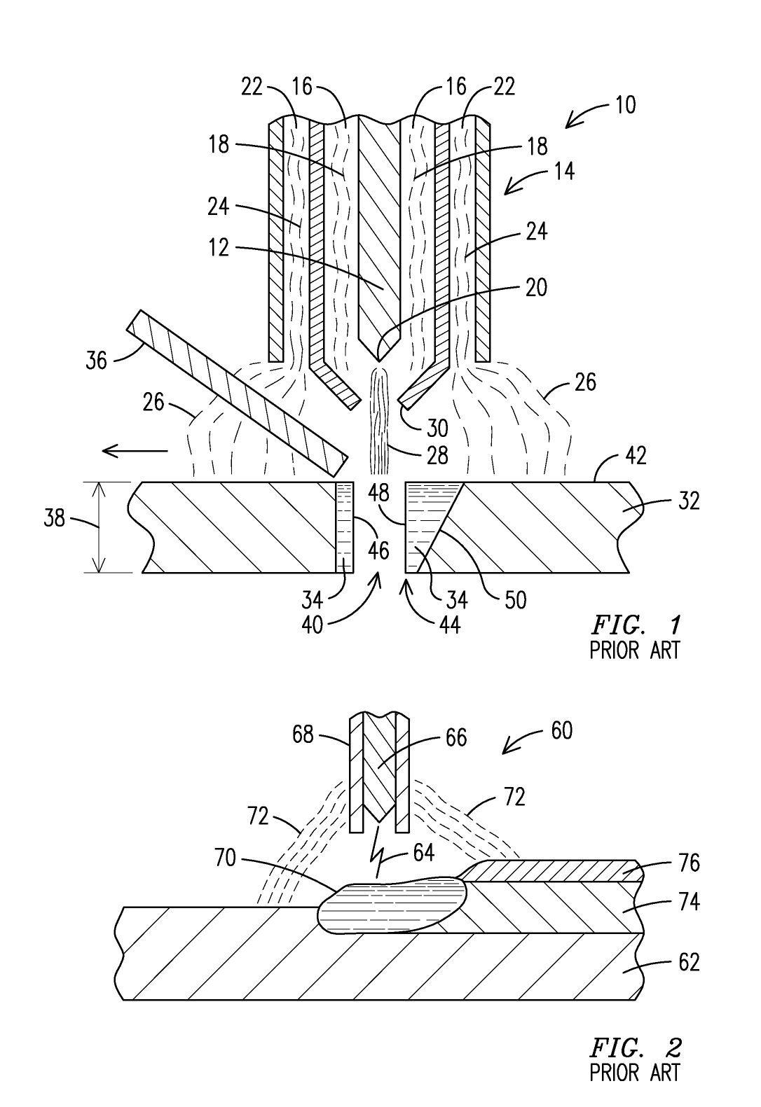

Conventional plasma arc welding 10 is illustrated in FIG. 1. In PAW, a tungsten or tungsten alloy electrode 12 is contained in a torch body 14. The torch body 14 further includes torch cavity 16 which contains the electrode 12 and delivers orifice gas 18 to the electrode tip 20, and a shielding gas path 22 for delivering discrete shielding gas 24 to the shielded region 26 of the weld. In PAW the electrode tip 20 does not protrude from the bottom of the torch body 14. Instead, plasma 28 traverses through a torch cavity orifice 30 to contact a substrate 32. The plasma 28 melts the substrate 32 forming a weld pool 34. As used herein, a weld pool is a pool of molten material that will cool into a weld bead. The molten materials in the weld pool may include substrate material, flux that hasn't or won't make it to slag, and filler material, unless the welding process is autogeneous, in which case no filler material is used. A weld bead (fusion zone) is molten material that has solidified. Slag includes flux on a surface of the weld pool and weld bead that would otherwise be exposed to the atmosphere, and possibly extending onto the substrate. Slag is first molten, then solidifies, and in both forms provides shielding for the weld pool and weld bead from atmospheric contaminants. Slag may contain flux and impurities from the substrate (if it provides a “cleaning” function), and/or oxygen from the substrate (if it provides a deoxidizing function). A deposit may include filler material (if used) and any flux that did not make it to slag. (If the welding process is autogenous, then the deposit would only be flux that didn't make it to slag and the weld bead would include melted substrate and such flux).

If a filler material 36 is used, the weld pool 34 may be a mixture of melted substrate 32 and melted filler material 36. If no filler material 36 is used (i.e. an autogenous weld), the weld pool 34 may be simply be melted substrate material. In “transferred arc mode” (i.e. “keyhole” mode), where the electrode is normally negative and the substrate 32 is positive, (as opposed to the torch body 14 being positive), the plasma 28 may traverse the entire substrate thickness 38 generating a keyhole 40. In such cases a weld pool 34 will have a top surface 42 and a root 44. In such a weld substrate 32 will melt at a leading edge 46 of the keyhole 40 and flow around the keyhole 40 to collect, cool, and solidify at a trailing edge 48 of the keyhole 40, forming a wake 50.

Limitations exist with the shielding used in this conventional PAW. First, as can be seen from FIG. 1, the shielded region 26 shields the top surface 42, but little, if any, discrete shielding gas 24 reaches the root 44. As a result the root surface 44 receives little shielding from atmospheric contaminants. Exacerbating this problem is the high velocity of the orifice gas 18 through the keyhole 40, which can entrain air toward the root 44. Second, weld pool 34 cooling and solidifying in the wake 50 may require additional discrete shielding gas 24 than is conventionally provided. Additional shielding gas could be provided by a separate gas purge in the wake of the field, but this may be difficult to provide with complex parts. Third, a discrete shielding gas 24 shields the surfaces of the weld pool 34 from atmospheric contaminants, but it does nothing regarding scavenging impurities on or in the substrates and/or any filler material. Removing such contaminants (i.e. volumetric cleansing) and deoxidation of the molten material (as well as surface cleansing and deoxidation of unmelted substrate proximate the weld pool) remains virtually unaddressed by the conventional shielding. However, these volumetric mechanisms (i.e. volumetric cleansing and deoxidation) are especially important in highly reactive metal alloys (i.e. Al, Ti, Ni, Co, etc.) and in repair operations where the surfaces to be welded may be incompletely pre-cleaned. Without these volumetric mechanisms, volumetric defects may occur. Weld defects that are associated with poor shielding include porosity within the weld bead, incomplete fusion of the weld bead to the substrate or another weld bead(s), poor blending of the weld to the substrate, undercut (a groove in the parent metal directly along the edges of the weld), sugaring (i.e. oxidation of a first pass of a multi-pass weld), and cracking.

Similar to PAW, laser beam welding (LBW) is conducted in atmosphere, and has the same shielding issues as described for PAW. For example, high velocity plasma suppression gas used in LBW can entrain air toward surfaces requiring shielding much like the aforementioned plasma orifice gas does with the PAW process. Unlike PAW and LBW, electron beam welding EBW is typically conducted in a vacuum chamber where it requires no supplemental shielding. However, EBW has been developed for applications outside of a vacuum chamber. In such out-of-vacuum cases, a portable device with a soft seal surrounds the area being welded and generates a vacuum region for the area being welded. This vacuum region slides along the substrate as the weld progresses. A disadvantage of this technique is that in imperfectly sealed vacuums air is drawn into the point of welding and the weld pool and heated material may react with oxygen or nitrogen etc in the air, causing contamination. Further, in full penetration welds, the back side (root side) of the weld is not within the vacuum, and thus the molten material and hot material are exposed to the atmosphere. In fact, due to the vacuum present on the top of the weld, air may be entrained to those areas and even into the top of the weld.

Upon recognizing the above-described limitations in conventional high energy density welding, the inventor has developed a technique that overcomes them. Specifically, the technique incorporates a flux into the conventional high energy density welding technique. The flux used is a type of flux that provides additional shielding, or in an embodiment, all of the shielding required for the high energy density welding technique. At a minimum the flux, once deposited into the weld pool, will form a slag on the surface of the weld bead effective to shield the weld bead from atmospheric contaminants. The flux may also form a molten shielding slag on the molten weld pool effective to shield the weld pool from atmospheric contaminants. The slag may also shield material in the heat affected zone (never melted but still heated substrate) from atmospheric contaminants. In an embodiment the flux will also form a shielding gas that will provide further shielding. Specifically, once melted the flux may also form a shielding gas in the region of the weld pool, and the shielding gas may displace the atmosphere in the region of the weld pool adjacent areas. The shielding gas may not react with the molten and/or heated materials, and thus may shield the molten and/or cooling materials from atmospheric contaminants. The shielding gas may work in conjunction with the slag to shield the weld pool and/or and cooling materials from the atmospheric contaminants. The flux may be delivered to the weld pool in any number of ways, which will be discussed in detail below.

Flux used in conventional shielded metal arc welding (SMAW) and submerged arc welding (SAW) produces a shielding gas and a shielding slag, and as a result would be ideally suited for use in the modified high energy density welding technique disclosed herein. However, any flux that provides at least a slag sufficient to provide shielding from atmospheric contaminants is acceptable. A SMAW technique using such a flux is disclosed in FIG. 2. In the SMAW technique 60, a SMAW substrate 62 is welded via an electric arc 64 delivered via a SMAW consumable electrode 66 coated with a SMAW consumable flux 68. The SMAW consumable electrode 66 and SMAW consumable flux 68 melt into a SMAW weld pool 70, which contains the melted SMAW consumable electrode 66, melted SMAW consumable flux 68, and melted SMAW substrate. A SMAW flux shielding gas 72 is formed that shields the SMAW weld pool 70, and may also shield surrounding areas, including the SMAW weld bead 74 and SMAW substrate in a heat affected zone. A SMAW slag 76 forms on a surface of the SMAW weld pool 70 and solidifies, shielding the SMAW weld pool 70 and the SMAW weld bead 74 from atmospheric contaminants. While the SMAW consumable flux 68 is molten in the SMAW weld pool 70, it may also scavenge impurities from the molten material, and/or deoxidize the molten material. As these are desired functions of a flux used in the modified high energy density welding technique, the flux used in SMAW would be a known, inexpensive, and readily available option for flux to be used in the modified high energy density welding technique.

Adding flux to the process yields additional advantages. For example, the use of flux offers the potential to shape the deposit. Such shaping may include controlling the shape of the crown (i.e. a top surface of the weld bead), controlling the shape of the back bead (i.e. a bottom surface of a full penetration weld bead), and wetting (i.e. proper blending/integration) of a deposit with the adjoining substrate and/or previously deposited passes. Furthermore, the flux may be neutral (i.e. contribute little or nothing to a weld-bead alloy chemistry), or it may be active, where it contributes to the weld-bead alloy chemistry. Finally, in an embodiment, the use of a flux in the modified high energy density welding technique enables one to simply dispense with the discrete shielding gas all together.

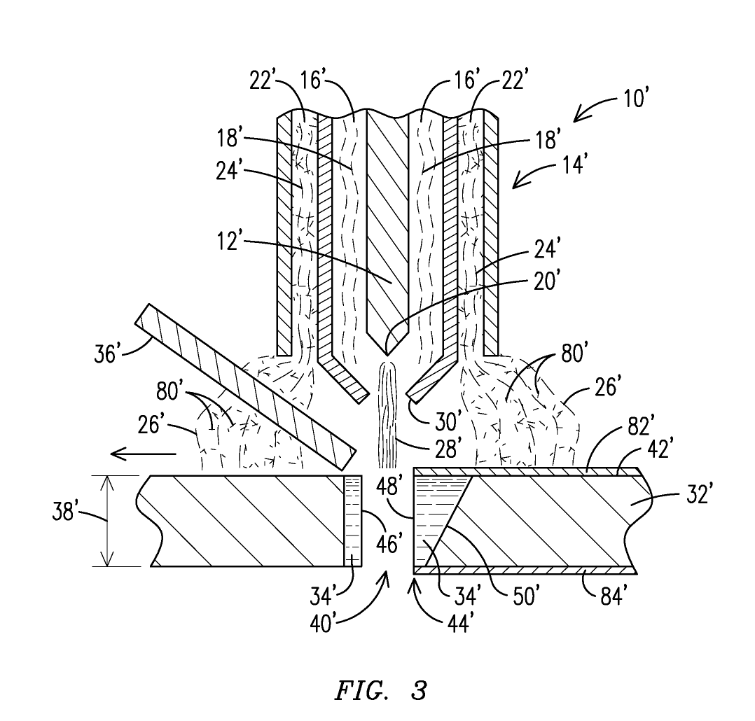

Flux can be incorporated into the process in any one of numerous ways. In an embodiment, flux can be in powder form. For a PAW technique, this can be accomplished using commercially available PAW torches configured for delivery of other types of powder (i.e. filler metal) or by specially designed PAW torches configured for powder delivery. Powder flux can be mixed with a gas flow that is already part of the high energy density welding technique. For example, in PAW the powder may be mixed with either or both of the orifice gas or the shielding gas. FIG. 3 depicts an embodiment of the invention which is a modification to the PAW technique of FIG. 1. The element numbers of FIG. 3 are similar to those in FIG. 1, but are denoted with a prime (′) to indicate the modified process, with additional elements described here related to the modification added. Specifically, in one embodiment flux powder 80′ may be mixed with the shielding gas and delivered via a shielding gas path 22′ to the weld pool 34′. In a through-hole (keyhole) process, a top surface slag 82′ may form on the surface of the weld pool 34′ and remain on a top of the substrate 32′ once cooled, thereby shielding the weld pool 34′ and substrate 32′ from the atmosphere. Similarly, a root surface slag 84′ may form on a root surface of the weld pool 34′ and remain on a bottom of the substrate 32′. In the embodiment of FIG. 3 the flux powder 80′ is depicted as being delivered via the shielding gas path 22′, but may be delivered in any of the ways described herein.

In LBW the powder may be mixed with the shielding gas. In LBW or EBW the powder flux may be preplaced on the substrate. Alternately, flux may be delivered directly to the point of welding in parallel with the high energy density welding technique, such as via a direct powder feeder to the point of welding. When delivered directly, the flux may be in powder form, or may be in solid form, such as wire, rod etc.

When in powder form and when a filler metal is used, the filler metal may also be in powder form. In such instances the flux powder and filler powder may be mixed together to form a mixture that is fed to the point of welding in any of the ways described above for delivery of the flux powder. However, the flux may be in powder form and delivered as described, and the filler may be in powder form yet delivered via an alternative path, or the filler may be in solid form and delivered via a different technique. Flux used in conventional SMAW and SAW techniques may be remeshed by grinding to a finer powder and used as the powder flux, and thus provides an inexpensive and commercially available option.

When such a flux is used in the modified high energy density welding technique the flux enters the weld pool. Melted flux then forms a molten slag on the surface of the weld pool. This slag is effective to shield the weld pool from atmospheric contaminants in a way not possible using the conventional high energy density welding techniques. While in the weld pool in a molten state the flux may also volumetrically clean and/or deoxidize the molten material prior to forming as a slag. In the case of a full penetration weld, slag may be formed on an exposed top surface and also on an exposed bottom surface (i.e. root) of the weld pool and subsequent weld bead. A slag on the exposed bottom surface may provide shielding from the atmospheric contaminants in a manner also not possible using the conventional high energy density welding techniques. Slag may also extend slightly onto substrate surfaces adjacent the weld pool/weld bead, and provide some shielding for them as well. Furthermore, the additional shielding provided by flux shielding gas may augment or even replace shielding gasses used in conventional high energy density welding techniques. In the former case shielding may be improved upon, and in the latter case the modified process may be made simpler. For example, eliminating the discrete shielding gas used in conventional high energy density welding techniques would eliminate the cost associated with the discrete shielding gas, and the equipment necessary to deliver it, reducing costs, while not sacrificing shielding. Volumetric cleansing and deoxidation are not even addressed by the conventional high energy density welding techniques, but are now possible.

A new and innovative technique has been disclosed that capitalizes on the advantages of high energy density welding as conventionally implemented, and the advantages of commercially available flux that shields a weld pool and weld bead using at least a slag and optionally a flux generated shielding gas. The flux used in the modified technique may also enable volumetrically cleansing and/or deoxidization the weld pool as well as surface cleansing and deoxidization the surface of unmelted substrate, which has not been possible until this technique. It also may be employed to help control the shape of the weld bead, and possibly eliminate a need for discrete shielding gas, also not possible until this technique. The modified high energy welding technique can be implemented quickly and inexpensively, producing improved welds with a minimum of cost increase, and thereby represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of shielding a weld, comprising
melting a first substrate using a high energy density welding technique selected from a group consisting of plasma arc welding, laser beam welding, and electron beam welding;
delivering a flux to a point of welding to form a weld pool comprising the melted first substrate, wherein the flux produces a slag effective to shield a weld bead from atmospheric contaminants.

2. The method of claim 1, wherein the flux also develops a flux shielding gas that shields the weld pool from the atmospheric contaminants.

3. The method of claim 1, comprising melting a second substrate using the high energy density welding technique and joining the first substrate to the second substrate by the high energy density welding technique, wherein the weld pool comprises the melted second substrate.

4. The method of claim 1, wherein the weld is a full penetration weld, and the method comprises forming a root surface slag on a weld pool root surface effective to shield the weld pool root surface from the atmospheric contaminants.

5. The method of claim 1, wherein the flux also performs at least one process selected from the group consisting of removing impurities from the weld pool, deoxidizing the weld pool, and contributing to a weld pool chemistry.

6. The method of claim 1, wherein the flux is delivered to the point of welding in parallel with the high energy density welding technique.

7. The method of claim 1, wherein a filler material is also delivered to the point of welding.

8. The method of claim 7, wherein the flux comprises a powder form and the flux is mixed with powder filler to form a powder mix that is delivered to the point of welding.

9. The method of claim 1, wherein the high energy density welding technique is selected from a group consisting of plasma arc welding and laser beam welding.

10. The method of claim 9, wherein the flux comprises a powder form and is delivered to the point of welding by a discrete shielding gas.

11. The method of claim 10, wherein filler material is mixed with powder filler to form a powder mix that is delivered to the point of welding by the discrete shielding gas.

12. The method of claim 9, wherein no discrete shielding gas is used.

13. The method of claim 1, wherein the high energy density welding technique comprises plasma arc welding, and wherein the flux comprises a powder form and is delivered to the point of welding within an orifice gas.

14. The method of claim 13, wherein the flux is mixed with a powder filler material to form a mixture that is delivered to the point of welding within the orifice gas.

15. The method of claim 1, wherein the high energy density welding technique is selected from a group consisting of laser beam welding and electron beam welding, wherein the flux is preplaced proximate the point of welding.

16. The method of claim 15, wherein the flux comprises a powder form and is mixed with a powder filler material to form a mixture that is preplaced proximate the point of welding.

17. The method of claim 1, further comprising using flux characteristics to shape a weld bead feature, the weld bead feature comprising at least one of crown control, back bead shape, and wetting of deposit.

18. The method of claim 1, wherein the flux does not contribute to a deposit alloy chemistry.

19. The method of claim 1, wherein the flux contributes to a deposit alloy chemistry.

20. A method of shielding a weld, comprising:
penetrating fully a first substrate using a high energy density welding technique selected from a group consisting of plasma arc welding, laser beam welding, and electron beam welding to form a weld pool of melted first substrate at a point of welding;
delivering a flux to the point of welding to volumetrically scavenge impurities from the weld pool; and
forming a slag comprising the flux on all exposed weld pool surfaces and exposed weld bead surfaces effective to shield the exposed weld pool surfaces and the exposed weld bead surfaces from atmospheric contaminants.

21. The method of claim 20, comprising forming a flux shielding gas effective to shield the weld pool from the atmospheric contaminants.

22. The method of claim 20, comprising melting a second substrate using the high energy density welding technique, wherein the weld pool comprises the melted second substrate, thereby joining the first substrate to the second substrate.

23. The method of claim 20, wherein the flux comprises a powder form, a powder filler is mixed with the flux to form a mixture, and the mixture is delivered to the point of welding.

24. A method of shielding a weld, comprising:
melting a full thickness of a first substrate and a full thickness of a second substrate into a weld pool using a high energy density welding technique selected from a group consisting of plasma arc welding, laser beam welding, and electron beam welding;
mixing a powdered filler and powder flux into a mixture;
delivering the mixture to the weld pool to volumetrically scavenge impurities from the weld pool, to form a flux shielding gas effective to shield the weld pool from atmospheric contaminants, and to form a slag on an exposed weld pool surface effective to shield the exposed weld pool surface from the atmospheric contaminants.
